(19) United States
(12) Patent Application Publication
(10) Pub. No.: US 2006/0226972 A1
(43) Pub. Date: Oct. 12, 2006

(54) Wireless emergency smoke notification system

(76) Inventor: David Huntington Smith, Snellville, GA (US)

Correspondence Address: DAVID HUNTINGTON SMITH, 1948 KENTLAND PLACE, SNELLVILLE, GA, 30078, US

(21) Appl. No.: 11/103,003

(22) Filed: Apr. 11, 2005

(51) Int. Cl. G08B 1/08

(52) U.S. Cl. 340/539.1

(57) ABSTRACT

The present invention concerns a wireless emergency alarm notification system for detecting a signal produced by a pre-existing smoke detector in a structure and for notifying persons in the immediate vicinity of a structure and in the surrounding area, as well as emergency personnel, of an emergency situation. The system includes a wireless sensor unit positioned nearby to a smoke detector for detecting an audible signal produced by the smoke detector in an emergency situation and a wireless receiver unit positioned on the exterior of the structure for receiving sensor signals from the sensor unit and activating an audible alarm and/or visible indicators. The sensor unit is comprised of a microphone for detecting a signal from the smoke detector, a control unit for determining the quality and/or quantity of the pre-existing smoke detector audible signal, a transmitter for transmitting an FM signal to a receiver, and a independent power source such as a battery. The receiver unit is comprised of an antenna, a FM tuner, FM receiver, power source, and a control unit for generating audible and/or visible alarms. In larger structures there may be numerous smoke detection systems each preferably having both a sensor unit and a receiver unit.

### BACKGROUND OF THE INVENTION

Fires occur frequently throughout the world, often-causing severe injuries or fatalities to human beings and animals. Each year, over three million fires leading to approximately 29,000 injuries and 4,500 deaths are reported in the United States alone. Each year, fire kills more Americans than all natural disasters combined and over 80% of all fire deaths occur in the home.

The total annual costs resulting from property losses caused by fires in the United States has been estimated to be over one hundred billion dollars. Fire Officials have recognized the need for early detection in order to reduce the severity of fire damage and the ability of the occupants to survive the fire conditions. Numerous inventions have attempted to assist with early notification of a fire situation. The smoke detector has been widely accepted throughout the world as one of the best methods for early detection of a fire situation. The invention of the smoke detector has greatly reduced the number of fire deaths and injuries. About 70% of all house fires occur while structures are unoccupied resulting in a greater amount of damage to the structure due to the lack of early fire detection.

Fires frequently cause buildings to collapse, thereby exposing occupants to a risk of severe injury or death from collapsed building materials and falling debris. Smoke contains toxic gases, such as carbon monoxide. It is widely acknowledged that carbon monoxide, which incapacitates fire victims, is the most frequent cause of death in building-related fires. The remainder of the deaths in these fires are generally caused by burns and collapsing structures. Fires frequently spread rapidly throughout residential structures due to the heavy fuel load which is present in buildings. This heavy fuel load always produces deadly smoke. The production of deadly smoke is most commonly a result of a lack of early fire detection and intervention.

The present invention relates generally to smoke detection systems, and more specifically to a system for monitoring one or more smoke detector's within a structure and alerting persons both within the structure and exterior of the structure to the existence of an emergency situation such as a fire.

Numerous security systems for monitoring smoke conditions of structures, such as houses are known. These smoke detection systems may employ different sensing devices, including ion detectors or smoke particle detectors. These smoke detection devices alert persons in a specific area about the presence of smoke. They do not alert other persons within the structure and in the nearby vicinity, or on the exterior of a fire or smoke condition. Further, smoke detection systems that have an ability to alert persons in the nearby vicinity to a fire condition disadvantageously do not operate with pre-existing smoke detector s located in a structure. These systems, generally disadvantageous, require a constant supply of electricity, are expensive, and a monitoring service is required to alert authorities to a fire condition.

There currently exists a need for a wireless emergency alarm notification system which is able to monitor a pre-existing smoke detector for activation, and to alert residents or other inhabitants of a structure, neighbors and persons in the peripheral vicinity about the existence of an emergency condition such as a fire or the presence of carbon monoxide. It would be desirable to provide such a system which is wireless. It would also be desirable to provide such a system which has a self-contained power source and is independent of public power sources. It is desirable to provide such a system with a visible strobe light or other visual indicator to guide emergency personnel to the scene of the emergency situation. It would be further desirable to provide a wireless emergency alarm notification system which requires minimal installation and is economical to purchase. It would also be desirable to provide a system which does not rely on telephone communication to notify other persons, neighbors, bystanders or persons in the periphery of the presence of an emergency situation such as a fire or the presence of carbon monoxide.

U.S. Pat. No. 5,786,767 (Severino, 1998) describes a home safety system comprising a smoke detector, a carbon monoxide detector and a microphone connected to a transmitter. A portable receiver receives signals from the transmitter and broadcasts the signals to alert an individual monitoring the conditions to the presence of smoke or carbon monoxide. This home safety system does not utilize pre-existing smoke detectors. In addition, it is not a permanently mounted system.

U.S. Pat. No. 6,646,566 (Tanguay, 2003) describes a sensor alarm which provides an alarm notification of a dangerous condition within a monitored space, further provides notice of its current stated condition, from among several states, with distinct a message comprising a combination of encoded audible and visible mnemonics annunciations. This invention provides interconnection of alarm systems but is not wireless and does not utilize pre-existing smoke detectors. This invention is also not economical in design or practical for single family residential application.

U.S. Pat. No. 5,889,468 (Banga, 1999) describes an extra security alarm system for monitoring conditions within a predetermined monitoring area and alerting persons in the vicinity and appropriate emergency personnel of an emergency situation. While this system may be useful it is not easy to install and it also does not utilize pre-existing smoke detectors.

U.S. Pat. No. 5,745,040 (Loughridge, 1998) describes an outdoor alerting device for smoke alarms including an alarm detecting and alerting device drive unit and an exterior alerting device. While this device does accomplish alerting persons on the exterior of the monitored area, it lacks wireless technology and utilizes cables to interconnect the monitoring and alarm device. The installation of the cables requires additional installation and additional costs. It is more desirable to utilize a system whereas installation is minimal and cost is decreased.

U.S. Pat. No. 6,420,973 (Acevado, 2002) describes a wireless detection system for monitoring an area for an emergency situation. This system includes a plurality of detector units inclusive of detector units strategically positioned throughout the monitored area. Each of the plurality of detector units include a detector for sensing one of a characteristic and condition within a section of the monitored area and generating a signal indicative of the monitored area. This system utilizes AC power from the structure and does not utilize pre-existing smoke detectors.

U.S. Pat. No. 5,587,705 (Morris, 1996) is designed to provide early warning of the presence of an environmental condition of fire or smoke to persons in remote areas of a building with respect to the location of the environmental condition. While this system does utilize wireless technology between smoke detectors, it does not utilize pre-existing smoke detectors and it also does not utilize a separate receiving device which is not a smoke detector.

International Publication Number WO 01/93220 describes a modular communication and control system and method for detecting and monitoring at least one event or condition of interest relating generally to communication and control systems, and in particular, to a wireless, modular, system suitable for a variety of applications, comprising of building maintenance and control, premises security and personal safety.

International Publication Number WO 92/06456 describes a home alarm device, characterized in that the device comprises an air pressure sensor, a sound microphone, both being connected with a microprocessor, an alarm transmitter being connected with the microprocessor, where the microprocessor is programmed to select received signals from the pressure sensor and the microphone, thereby to recognize the received signals.

International Publication Number WO 03/023729 describes a smoke sensor for sensing smoke from the surrounding area and is combined into a wireless telecommunication apparatus, for instance a mobile phone, thereby using the power supply and sound-emitting unit already existing in the telecommunication apparatus. Additionally, an emergency central station may be called automatically upon smoke detection, when the telecommunication apparatus is connected to the wireless network.

International Publication Number WO 02/41278 describes a wireless monitoring unit system for monitoring and method of use of monitoring units and/or systems.

International Publication Number WO 01/33528 describes a reassurance monitoring apparatus is disclosed comprising a first assembly to be located in a room with the person being monitored; comprised of a microphone adapted to convert sounds generated by the patient into an audio signal.

Japanese Patent application JP10289391A2 describes a wireless system for providing environmental information—includes a microphone sensor attached to transmitter and vibrator connected to receiver.

Japanese Patent Application Publication Number JP5056012A describing a emergency loudspeaker broadcasting system which has loudspeaker units connected respectively to distributed radio receivers which cordless microphones are linked by radio.

Significant differences exist between the wireless emergency alarm notification system of the present invention and the methods and devices described in the above patents and published patent applications.

### SUMMARY OF INVENTION

The present invention provides a wireless emergency alarm notification system that advantageously has an ability to monitor one or more pre-existing smoke detectors for activation, and to alert residents or other inhabitants of structures, as well as others that are located exterior to such structures, about the existence of an emergency situation, such as a fire. The wireless emergency alarm notification system of the invention advantageously are wireless, have a self-contained power source, are independent of public power sources and utilize pre-existing smoke detector (s). Consequently, these systems extremely advantageously are not subject to an interruption in electrical power service, which frequently occurs during fires or otherwise, such as during storms or blackouts. Interruptions in electrical power service during fires generally cause smoke detection or notification systems that rely upon public power sources to become inactive and ineffective, thereby exposing residents or other occupants of structures to a high degree of risk of injury or death from smoke inhalation or heat application injuries. The wireless emergency alarm notification system of the invention also advantageously does not rely upon telephone lines to notify monitoring stations about the existence of an emergency condition. Moreover, these systems advantageously can provide one or more visual indicators, such as strobe lights, that can guide emergency personnel to the scene of an emergency situation. Further, the wireless emergency alarm notification system is economical to manufacture, easy to install and use and is self contained. In addition, the wireless emergency alarm notification system generally does not require user intervention.

The wireless emergency alarm notification systems of the invention comprise: a sensor unit, wherein the sensor unit is positioned adjacent or near to a smoke detector(s) located in the interior of or exterior to a structure that produces one or more signals in response to a detection of smoke by the smoke detector, wherein the sensor unit has an ability to detect one or more signals produced by the smoke detectors and, in response to such signals, generates one or more FM signals, and wherein the sensor unit includes: a microphone, wherein the microphone has an ability to detect one or more signals generated by the smoke detector(s); a control unit, wherein the control unit has an ability to determine the quality of quantity sound and analyze the sound emitted by the smoke detector(s); a transmitter, wherein the transmitter only activates if a sound is produced from the smoke detector that has the same quality and quantity of the sound generated by the smoke detector(s), and wherein the transmitter has an ability to transmit one or more FM signals to a receiver unit located exterior to the structure; and a power source, wherein the power source has an ability to generate electrical energy to the components; and a receiver unit located in the interior of exterior to the structure, wherein the receiver unit has an ability to receive one or more FM signals generated by the transmitter of the sensor unit and, in response to such FM signals, activate one or more audible alarms, one or more visual indicators or a combination of one or more audible alarms and one or more visual indicators, and wherein the receiver unit includes: an antenna, wherein the antenna has an ability to receive the FM signal; an FM tuner, wherein the FM tuner has an ability to detect the correct FM frequency, an FM receiver, wherein the FM receiver has an ability to receive FM signals; a independent power source, wherein the power source has an ability to energize the components; and a control unit, wherein the control unit has an ability to determine the quality and quantity of the signals generated by the smoke detection unit; wherein the wireless emergency alarm notification system has an ability to alert one or more persons located exterior to a structure or in the periphery of the structure containing the wireless emergency alarm notification system of the presence of smoke in the interior of the structure using radio frequency wireless communication; a alarm reset, wherein the alarm reset has the ability to reset the system to a state of readiness.

### BRIEF DESCRIPTION OF THE DRAWINGS

FIG. 1 is a perspective view of an embodiment of the wireless emergency alarm notification system installed within a single story residential building.

FIG. 2 is a perspective view of an embodiment of the wireless emergency alarm notification system installed in a multifamily dwelling wherein one sensor unit is installed in each apartment and two receiver units are installed on the periphery of the dwelling.

FIG. 3 is a schematic diagram of the sensor/transmitter unit for use with the wireless emergency alarm notification system.

FIG. 4 is a schematic diagram of the receiver unit for use with the wireless emergency alarm notification system.

FIG. 5 is a front perspective view of a transmitter unit of the wireless emergency alarm notification system.

FIG. 6 is a front perspective view of a receiver unit of the wireless emergency alarm notification system.

### DESCRIPTION OF THE REFERENCED NUMERALS

10 wireless emergency alarm notification system
11 electret microphone
12 decibel and pitch potentiometer
13 timing potentiometer
14 transmitting tuner
15 transmitter
16 transmitting antenna
17 independent power source
18 delay timer
19 voltage regulator
20 battery monitor
21 LED
22 reset button
23 transmitter control unit
24 receiver antenna
25 receiver
26 receiver tuner
27 receiver power source
28 receiver control unit
29 audible alarm
30 strobe light
31 LED's
32 Pre-existing smoke detector
33 Transmitter unit
34 Receiver Unit

### DESCRIPTION OF THE PREFERRED EMBODIMENTS

For the purpose of illustrating the wireless emergency alarm notification system, processes, uses and methods of manufacture of the present invention, there are shown in the drawings, which form a material part of this disclosure, various, schematic and other views of a preferred embodiment of a wireless emergency alarm notification system of the invention.

The various components or parts of the preferred embodiment of the wireless emergency alarm notification system of the invention may be generally arranged in the manner shown in the drawings, or described herein, or otherwise. The present invention is not limited to the precise arrangements, configurations, dimensions, instrumentalities, components, materials, angles or conditions shown in these drawings, or described herein. These arrangements, configurations, dimensions, instrumentalities, components, materials, angles and/or conditions may be otherwise, as circumstances require or are desired. For example, fewer or additional electronic components such as FM receivers, FM transmitters, power sources, microphones, sensors, potentiometers, timers, batteries, battery monitors, voltage regulators, LED's and/or other components or parts may be employed. Further, these components and parts may be arranged in a wide variety of different manners or patterns. The location of the various components or parts of the wireless emergency alarm notification systems, and the means employed for attaching one or more components, parts and/or areas of the wireless emergency alarm notification systems to one or more other components, parts and/or areas of the wireless emergency alarm notification systems, may also be varied. Moreover, rather than attaching various components, parts and/or areas of the wireless emergency alarm notification systems together, one or more components, parts and/or areas of the wireless emergency alarm notification systems may be machined or otherwise formed from one piece of metal or other material. Still further, various components, parts and/or areas of the wireless emergency alarm notification systems may be either permanently, or removably, attached with other components, parts and/or areas of the wireless emergency alarm notification systems, and may be movable or not movable. Removably attached components and parts are often preferable because such components and parts may generally be replaced in a simpler and more cost-effective manner in the event that they become worn, damaged or destroyed. Various materials preferred in the construction of the housing of the subject components may include metal, plastic or any other protective solid material suitable for containing and protecting the electronic components within the housing. The electronic components which comprise the wireless emergency alarm notification system can be constructed of materials common to the electronics industry and readily available for consumer use. The wireless emergency alarm notification system can be manufactured in various sizes which are visually appealing and economical to design, manufacture, package and distribute.

The present invention may be understood more readily by reference to the following detailed description of the preferred embodiments of the invention, and to the examples included therein.

A specific and preferred embodiment of the wireless emergency alarm notification systems of the invention will now be described with reference to the drawings.

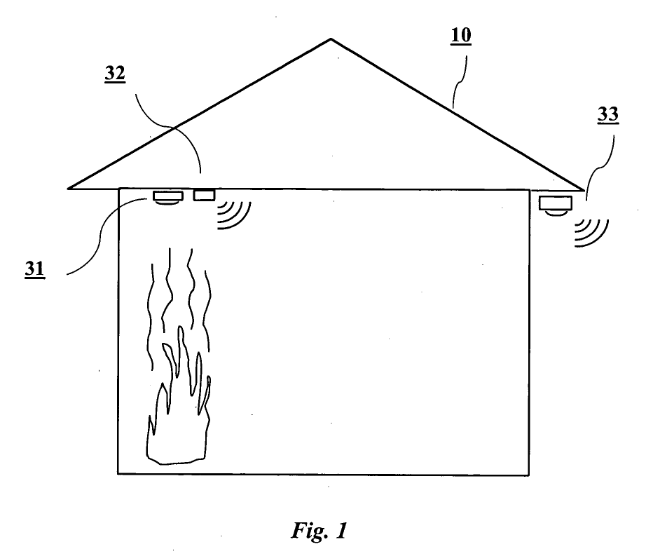

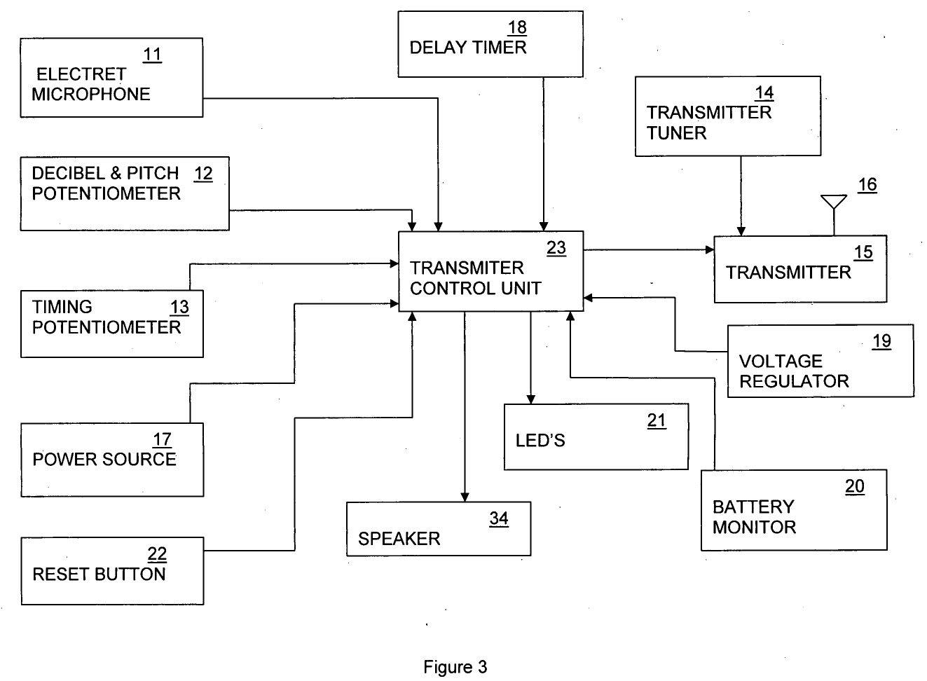

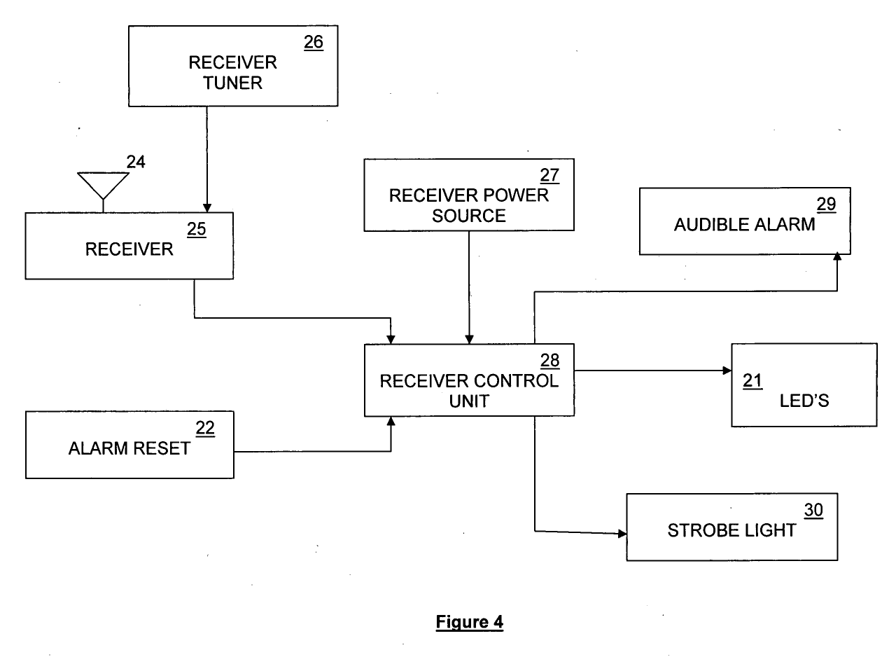

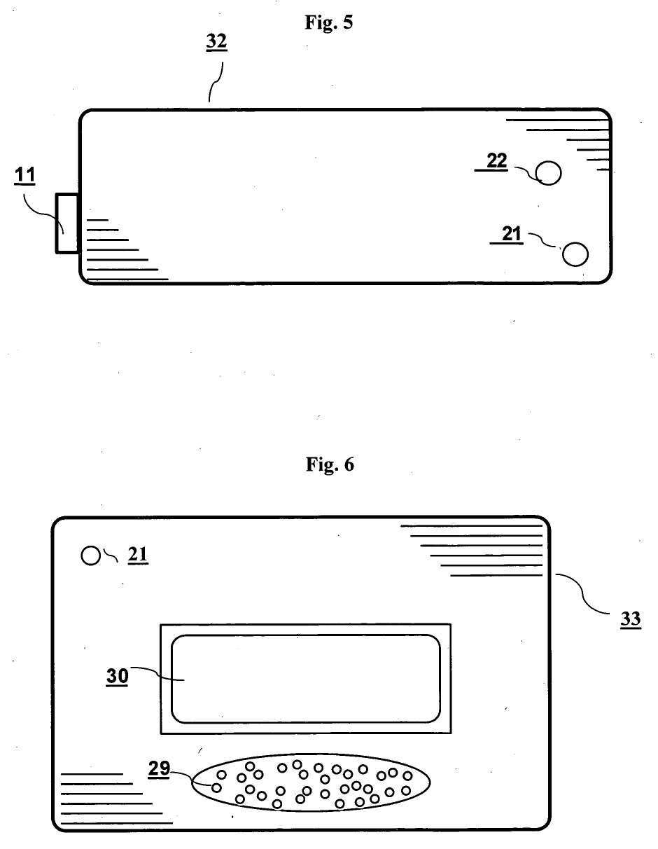

Referring to FIGS. 1-6, there is shown in FIGS. 1, 2, 3, 4, 5 & 6 a preferred wireless emergency alarm notification system of the invention, which is indicated generally by the number 10. The transmitter unit 32 which is mounted in the immediate vicinity of the pre-existing smoke detector is generally indicated by the number 31.

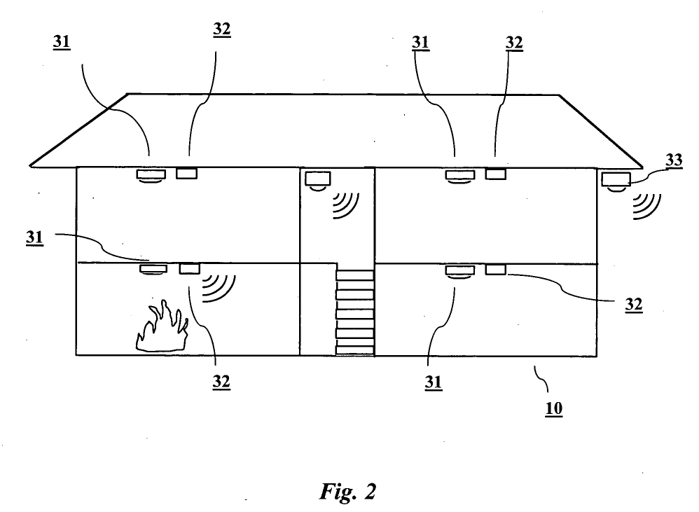

The wireless emergency alarm notification system 10 is illustrated in FIG. 1 installed in a single family residential dwelling. The wireless emergency alarm notification system 10 is designed to monitor a pre-existing smoke detector 31 and to activate only upon the sounding of an alarm by the pre-existing smoke detector 31. In the presently described example the wireless emergency alarm notification system 10 is located attached to a single 11. family dwelling FIG. 1, but in practice the wireless emergency alarm notification system 10 could be attached to any type of structure, comprised of an office building, commercial building, storage facility, multi-family dwelling FIG. 2, etc., in which a smoke detector may be installed, the only limitation being the effective transmission range of the transmitter 15. The transmitter 15 is designed to activate only upon detecting the proper quality and quantity of an audible signal from the pre-existing smoke detector 31.

One residential wireless emergency alarm notification system transmitter unit 32 is located on an interior wall immediately adjacent to a pre-existing smoke detector 31. Each transmitting unit 32 contains an electret microphone 11 which determines the presence of sound emitting from the pre-existing smoke detector 31. A decibel and pitch potentiometer 12 is set for a predetermined decibel, pitch and frequency levels emitting from the pre-existing smoke detector 31. A second potentiometer 13 determines that the audible sound emitted by the pre-existing smoke detector 31 is produced for a minimum time period before the transmitter control unit 23 is activated. An independent power source 17 of preference is utilized to energize all components of the device. A reset button 22 is included in the event of inadvertent activation of the pre-existing smoke detector 31. The delay timer 18 permits a predetermined time interval to pass before the transmitter control unit 23 activates the transmitter 15. The wireless emergency alarm notification system 10 is monitored with a battery monitor 20 and a voltage regulator 19 which recognizes a weak signal from the power source 17. If a weak signal is detected the speaker 34 will emit a sound notifying the user of a weak signal.

The residential wireless emergency alarm notification system receiver unit 33 receives a signal from the transmitter unit 32. The receiver antenna 24 will transmit the signal to a receiver tuner 26 and the receiver 25. The receiver unit 33 is energized by an independent receiver power source 27 which energizes all components of the receiver unit 33. Upon receipt of a signal the receiver control unit 28 activates the audible alarm 29, the strobe light 30 and the LEDs 21. A reset button 22 is provided to reset the receiver unit 33 in the event of inadvertent activation of the receiver unit 33.

All of the materials, components and equipment that are employed to carry out the processes of the invention, and that are employed to make the wireless emergency alarm notification systems of the invention, and all of the materials, components and equipment that are employed in the examples, are commercially available from sources known by those of skill in the art. Sources for these items include but are not limited to, for example, Digi-key Corporation (Thief River Falls, Minn.); Jameco Electronics (Belmont Calif.); Moyer Electronics (Hazelton, Pa.); HSC Electronic Supply Company (Santa Clara, Calif.)

For example:

In a single family residential dwelling the transmitter is placed adjacent to the pre-existing smoke detector and the receiver is placed on the exterior of the dwelling in any area. When the Smoke detector activates the wireless emergency alarm notification system transmitter sends a wireless FM signal to the exterior receiver unit. Upon receipt of the FM signal the receiver unit emits a visual and audible alarm signifying the activation of the smoke detector in the interior of the single family dwelling. This audible and visual alarm alerts persons in the area of the smoke condition within the structure allowing for the notification of emergency personnel, evacuation of the structure, and intervention to cease the emergency situation and reduce the property damage and enhance the probability of survival.

Various modifications, additions and/or deletions can be made to the wireless emergency alarm notification system described in this example, and to the sizes, other parameters and steps described above. All such modifications, additions and deletions are within the scope of the appended claims and form part of the present application.

For Example:

In a commercial or mercantile structure one or more wireless emergency alarm notification systems is placed in the interior of the structure in the desired area adjacent to a smoke detector. When the Smoke detector activates the wireless emergency alarm notification system transmitter sends a wireless FM signal to the exterior receiver unit. Upon receipt of the FM signal the receiver unit emits a visual and audible alarm signifying the activation of the smoke detector in the interior of the commercial or mercantile structure. This audible and visual alarm alerts persons in the area of the smoke condition within the structure allowing for the notification of emergency personnel, evacuation of the structure, and allows for early intervention to cease the emergency situation and reduce the property damage and enhance the probability of survival.

Various modifications, additions and/or deletions can be made to the wireless emergency alarm notification system described in this example, and to the sizes, other parameters and steps described above. All such modifications, additions and deletions are within the scope of the appended claims and form part of the present application.

For Example:

In a multi-family dwelling one or more wireless emergency alarm notification systems is placed in the interior of the structure in the desired area adjacent to a smoke detector. When the Smoke detector activates the wireless emergency alarm notification system transmitter sends a wireless FM signal to the exterior receiver unit. Upon receipt of the FM signal the receiver unit emits a visual and audible alarm signifying the activation of the smoke detector in the interior of the commercial or mercantile structure. This audible and visual alarm alerts persons in the area of the smoke condition within the structure allowing for the notification of emergency personnel, evacuation of the structure, and allows for early intervention to cease the emergency situation and reduce the property damage and enhance the probability of survival.

Various modifications, additions and/or deletions can be made to the wireless emergency alarm notification system described in this example, and to the sizes, other parameters and steps described above. All such modifications, additions and deletions are within the scope of the appended claims and form part of the present application.

For Example:

In an apartment building one or more wireless emergency alarm notification systems is placed adjacent to each smoke detector in each apartment unit. When the smoke detector activates the wireless emergency alarm notification system transmitter sends a wireless FM signal to one or more exterior receiver units. Upon receipt of the FM signal the receiver unit(s) emits a visual and audible alarm signifying the activation of the smoke detector in the interior of the commercial or mercantile structure. This audible and visual alarm alerts persons in the area of the smoke condition within the structure allowing for the notification of emergency personnel, evacuation of the structure, and allows for early intervention to cease the emergency situation and reduce the property damage and enhance the probability of survival.

Various modifications, additions and/or deletions can be made to the wireless emergency alarm notification system described in this example, and to the sizes, other parameters and steps described above. All such modifications, additions and deletions are within the scope of the appended claims and form part of the present application.

Specific wireless emergency alarm notification systems and processes within the scope of the invention include, but are not limited to, the wireless emergency alarm notification systems and processes discussed in detail herein and/or illustrated in the drawings contained herein. Contemplated equivalents of the wireless emergency alarm notification systems and processes described herein and/or illustrated in the drawings contained herein include wireless emergency alarm notification systems and processes that otherwise correspond thereto, and that have the same or similar general properties and/or components thereof, wherein one or more simple or other variations, deletions or additions of steps, conditions, components, materials, sizes, arrangements and/or like variables are made.

The following non-limiting examples describe and illustrate the preparation and testing of preferred wireless emergency alarm notification systems within the present invention, as well as other aspects of the invention. These examples are intended to be merely illustrative of the wireless emergency alarm notification systems of the present invention, and not limiting thereof in either scope of spirit. Those of skill in the art will readily understand that variations of certain of the conditions, materials, components, sizes, arrangements and/or steps employed in the procedures described in the examples can be used to prepare and test these wireless emergency alarm notification systems.

For purposes of clarity, various terms and phrases used throughout this specification and the appended claims are defined in the manner set forth below. If a term or phrase used in this specification, or in the appended claims, is not defined below, or otherwise in this specification, the term or phrase should be given its ordinary meaning.

The term “activate” as used herein means to become active, to commence working, to transmit a FM signal or other sensor signal or device.

The phrase “audible alarm” as used herein means any device, apparatus or system that has an ability to produce one or more sounds that are sufficiently loud to enable a human being to become alerted to a potential or actual emergency situation, such as a fire. Examples of audible alarms include, but are not limited to, loud siren sounds, loud beeping sounds and other emitted signals capable of drawing attention.

The term “combustion” as used herein means a chemical change, especially oxidation, resulting from an exothermic reaction of a substance with an oxidizer, and generally accompanied by the production of heat, light, flames, glowing and/or the emission of smoke.

The term “wireless” as used herein means without the use of wires.

The phrase “self-contained” as used herein means having all parts needed for working order and/or complete and independent.

The term “economical” as used herein means low in cost.

The phrase “emergency personnel” as used herein includes, but is not limited to, police, fire fighters, medical personnel (doctors, nurses, emergency medical technicians, ambulance drivers, persons who render aid, etc.) and the like.

The phrases “fire” and “fire condition” as used herein mean a chemical reaction that releases heat and/or light, and that is often rapid and persistent, for example, the exothermic combination of a combustible substance with oxygen.

The term “plurality” as used herein means more than one, such as two, three, four, five, six, seven, eight, nine, ten, fifteen, twenty or the like.

The term “pushed” as used herein in connection with a reset button means that the reset button is pushed or otherwise activated.

The term “sensor” as used herein means a device which detects and responds to a electronically generated signal.

“Signals” as used herein means a means of communication used to convey information.

The phrases “smoke” and “smoke condition” as used herein mean a generally visible suspension of solid, liquid or other particles in gases resulting from combustion or pyrolysis. Smoke resulting from a fire generally contains deadly gases, such as carbon monoxide.

The phrase “smoke detector” as used herein includes, but is not limited to a device which detects smoke in the atmosphere. A wide variety of smoke detector s are commercially available and are manufactured by companies such as Kiddie & Maple Leaf and are available in most hardware stores and other retail establishments such as Home Depot, Wal-Mart, K-Mart and Target.

The phrase “smoke detection system” as used herein includes, but is not limited to, any of a wide variety of different types of commercially available smoke detectors and smoke alarms. Such smoke detector s can be purchased, for example, from most hardware stores (or stores that sell hardware as well as other items), such as Home Depot, Ace Hardware, Wal-Mart, Target and K-Mart.

The phrase “structure” as used herein includes, but is not limited to, a residential or commercial building, such as a house (a single- or multi-family residence), a townhouse, a condominium, an apartment, a duplex, a hotel, a motel, a school, a grocery store, a convenience store, a gas station, a business, an office building, a manufacturing plant, a restaurant, a clinic, a hospital, a theater, etc., or a portion of a structure, such as an attic, a crawl space or a basement.

The phrase “visual indicator” as used herein means any device, apparatus or system that has an ability to produce one or more visual indications that are sufficient to enable a human being that has an ability to see to become alerted to a potential or actual emergency situation, such as a fire. Examples of visual indicators include, but are not limited to, one or more strobe or other flashing lights, illuminated lighting and the like.

The phrase “wireless communication” as used herein means the electronic transfer of information and/or signals without electronic wires.

The phrase “power source” as used herein includes, but is not limited to, a device or component available for doing work.

The phrase “public power source” as used herein includes, but is not limited electrical power available for purchase by the consumer and normally used to energize all common electrical systems. Companies providing power of this nature include like Georgia Power Company and also Government utility companies.

The phrase “monitoring stations” as used herein includes, but is not limited to a central alarm location which the alarm communicates with normally by telephone. This location notifies emergency personnel in the event of the activation of an alarm sensor within the monitored area. Companies which provide services of this nature include ADT & Wells Fargo.

As discussed within the parameters of this application the wireless emergency alarm notification system was tested in order to scientifically validify the application parameters of the wireless emergency alarm notification system. Sound Level Testing of a residential dwelling without a wireless emergency alarm notification system registered 42 decibels on the exterior of a typical residential dwelling 20 meters from the dwelling with the pre-existing smoke detector activated on the interior of the structure. Sound level testing of a residential dwelling equipped with a wireless emergency alarm notification system registered 110 decibels on the exterior of a typical residential dwelling 20 meters from the dwelling. The application of the wireless emergency alarm notification system provided a 262% increase in decibel level resulting in an increased awareness of an emergency situation in the subject dwelling. This 262% increase in awareness to the presence of a fire or other emergency condition is a proven value to the community resulting in the decrease of property damage and loss of life due to the inherent dangers encountered during a fire or other emergency situation such as carbon monoxide release into a residence.

While the wireless emergency alarm notification systems and processes of the present invention have been shown and described herein with specificity, and with reference to certain preferred embodiments thereof, those of ordinary skill in the art will recognize numerous variations, modifications and substitutions of that which has been shown and described which can be made, and which are within the scope and spirit of the invention, as by adding, combining, deleting or subdividing components or steps, by substituting equivalents, or by varying conditions, components, materials, sizes or arrangements, while retaining significant advantages of the wireless emergency alarm notification systems and processes of the invention, which are defined in the claims that follow. It is intended, therefore, that all of these modifications, variations and substitutions be within the scope and spirit of the present invention as described and claimed herein, and that the invention be limited only by the scope of the claims which follow, and that such claims be interpreted as broadly as possible.

Throughout this patent application, various books, patents, published patent applications, have been cited. The teachings present in each of these books, patents, published patent applications, are hereby incorporated by reference herein without admission that such is prior art. Available published materials which may assist in the construction and application of this invention include but are not limited to “Introduction to Radio Frequency Design by W. H. Hayward (Published by American Radio Relay League); Basic Electricity by Van Valkenburgh (Delmar Learning); Electronic Principles by Albert Paul Malvino (McGraw Hill Science); Teach Yourself Electricity and Electronics by Stan Giblisco (McGraw Hill\Tab Electronics); The Art of Electronics by Paul Horowitz (Cambridge University Press).

What is claimed is:

1. A wireless emergency alarm notification system comprising:
(a) a sensor unit, wherein the sensor unit is positioned adjacent or near to a smoke detection system located in the interior of or exterior to a structure that produces one or more signals in response to a detection of smoke, wherein the sensor unit has an ability to detect one or more signals produced by the smoke detector(s) and, in response to such signals, generates one or more radio signals, and wherein the sensor unit includes:
(1) a microphone, wherein the microphone has an ability to detect one or more signals generated by the smoke detection system or carbon monoxide detection system;
(2) a control unit, wherein the control unit has an ability to determine the quality of the signals generated by the smoke detection unit or carbon detection system;
(3) a transmitter, wherein the transmitter only activates if a sound is produced from the smoke detector that has approximately the same decibel, pitch and frequency of the sound generated by the smoke detection system or carbon monoxide detection system, and wherein the transmitter has an ability to transmit one or more radio signals to a receiver unit located exterior to the structure; and
(4) a self contained power source, wherein the power source has an ability to energize the wireless emergency alarm notification system components and;
(b) a receiver unit located in the interior of or exterior to the structure, wherein the receiver unit has an ability to receive one or more radio signals generated by the transmitter of the sensor unit and, in response to such radio signals, activate one or more audible alarms, one or more visual indicators or a combination of one or more audible alarms and one or more visual indicators, and wherein the receiver unit includes:
(1) an antenna, wherein the antenna has an ability to detect the radio signal;
(2) a frequency modulated tuner, wherein the frequency modulated tuner has an ability to adjust the frequency modulated signal to the correct frequency;
(3) a frequency modulated receiver, wherein the frequency modulated receiver has an ability to receive and reproduce frequency modulated signals;
(4) a self contained power source, wherein the power source has an ability to energize the components; and
(5) a control unit, where the control unit has the ability to determine the quality of the signals generated by the smoke detection unit or carbon monoxide detection unit.
(6) An audible alarm, where the audible alarm has the ability to emit a sound capable of drawing attention to the presence of an emergency condition such as smoke or carbon monoxide in the interior of the structure.
(7) A strobe light, where the strobe light has the ability to emit an illuminated light source which draws attention to the presence of an emergency condition such as smoke or carbon monoxide in the interior of the structure.
wherein the wireless emergency alarm notification system has an ability to alert one or more human beings located exterior to a structure or in the periphery of the structure containing the wireless emergency alarm notification system of the presence of smoke in the interior of the structure using radio frequency wireless communication; a alarm reset, wherein the alarm reset has the ability to reset the system to a state of readiness;
1. Wherein the wireless emergency alarm notification system has an ability to alert one or more human beings located exterior to a structure containing the wireless emergency alarm notification system of the presence of smoke or an emergency situation in the area where the wireless emergency alarm notification system is located using wireless communication.

2. The smoke detection system of claim 1 wherein the transmitter includes a reset button, wherein if the reset button is pushed, the FM signal that is transmitted from the transmitter to the receiver unit becomes terminated.

3. The smoke detection system of claim 1 wherein the smoke detection system operates using radio frequency wireless FM communication.

4. The smoke detection system of claim 1 wherein the structure is a residential structure, mercantile structure or industrial structure.
